(19) United States
(12) Patent Application Publication
(10) Pub. No.: US 2003/0016227 A1
(43) Pub. Date: Jan. 23, 2003

(54) Adaptable large area display

(76) Inventor: Dennis L. Matthies, Princeton, Mercer, NJ (US)

Correspondence Address: Timothy N. Trop, TROP, PRUNER & HU, P.C., STE 100, 8554 KATY FWY, HOUSTON, TX, 77024-1805, US

(21) Appl. No.: 09/909,037

(22) Filed: Jul. 19, 2001

(51) Int. Cl. G09G 5/00

(52) U.S. Cl. 345/581

(57) ABSTRACT

A plurality of display image producing tiles may be abutted into a matrix and mounted on a structural supporting plate to produce a tiled display module. The tile display modules may be shipped and connected together on site to produce an overall display. Each of the tiled modules may be connected together to a back plate to produce the overall display. The tiles connected to a structural plate and the modules connected to a structural plate may be adjustably positionable with respect to one another in two or more dimensions.

### BACKGROUND

This invention relates generally to large area displays.

Large area displays create an enlarged display image by combining a series of smaller images produced by a plurality of tiles that are abutted together to form the overall displayed image. Because each tile can be separately fabricated, the overall large area display may be made in a more economical fashion. For example, because the larger the tile, the higher the probability of a defect, by using relatively small tiles which may be assembled into a larger display, the discard rate may be reduced and therefore manufacturing economies may be achieved.

Conventional current large area displays are made up of a combination of tiles, assembled in the combined format, and then shipped to the site for delivery. Thus, when the large area display arrives, it is simply put into position, electrically connected for immediate operation.

In many cases, these large area displays are not very portable. Because of their large size, it may be difficult to deliver the displays to a particular site. Since they must be custom manufactured, there is little flexibility in the size of the display after original assembly.

Thus, there is a need for large area displays that are more adaptable.

### BRIEF DESCRIPTION OF THE DRAWINGS

FIG. 1 is a front elevational view of a display in accordance with one embodiment of the present invention;

FIG. 2 is an enlarged front elevational view of one of the tiles used in the display shown in FIG. 1, in accordance with one embodiment of the present invention;

FIG. 3 is an enlarged side elevational view of the embodiment shown in FIG. 2;

FIG. 4 is an enlarged, partial cross-sectional view taken generally along the line 4-4 in FIG. 1;

FIG. 5 is an enlarged, rear elevational view of the tile shown in FIG. 2, in accordance with one embodiment of the present invention;

FIG. 5a is an enlarged, rear elevational view of another embodiment of the present invention;

FIG. 6 is a greatly enlarged exploded cross-sectional view taken generally along the line 6-6 in FIG. 5 in the course of assembly;

FIG. 7 is a greatly enlarged cross-sectional view taken generally along the line 6-6 after assembly in accordance with one embodiment of the present invention;

FIG. 8 is an enlarged perspective view of a mullion in accordance with one embodiment of the present invention;

FIG. 9 is a cross-sectional view taken generally along the line 9-9 in FIG. 8;

FIG. 10 is a partial, enlarged front elevational view of a portion of FIG. 1 where a plurality of tiles intersect;

FIG. 11 is an enlarged side elevational view of a module in accordance with one embodiment of the present invention;

FIG. 12 is an enlarged cross-sectional view taken generally along the line 12-12 in FIG. 1 in accordance with one embodiment of the present invention;

FIG. 13 is a rear plan view of the embodiment shown in FIG. 11 in accordance in one embodiment of the present invention.

FIG. 13a is a rear plan view in accordance with one embodiment of the present invention;

FIG. 14 is a schematic depiction of a signal distribution in accordance with one embodiment of the present invention; and

FIG. 15 is a schematic depiction of a signal distribution scheme in accordance with one embodiment of the present invention;

FIG. 16 is a partial side elevational view in accordance with one embodiment of the present invention; and

FIG. 17 is a partial side elevational view of another embodiment of the present invention.

### DETAILED DESCRIPTION

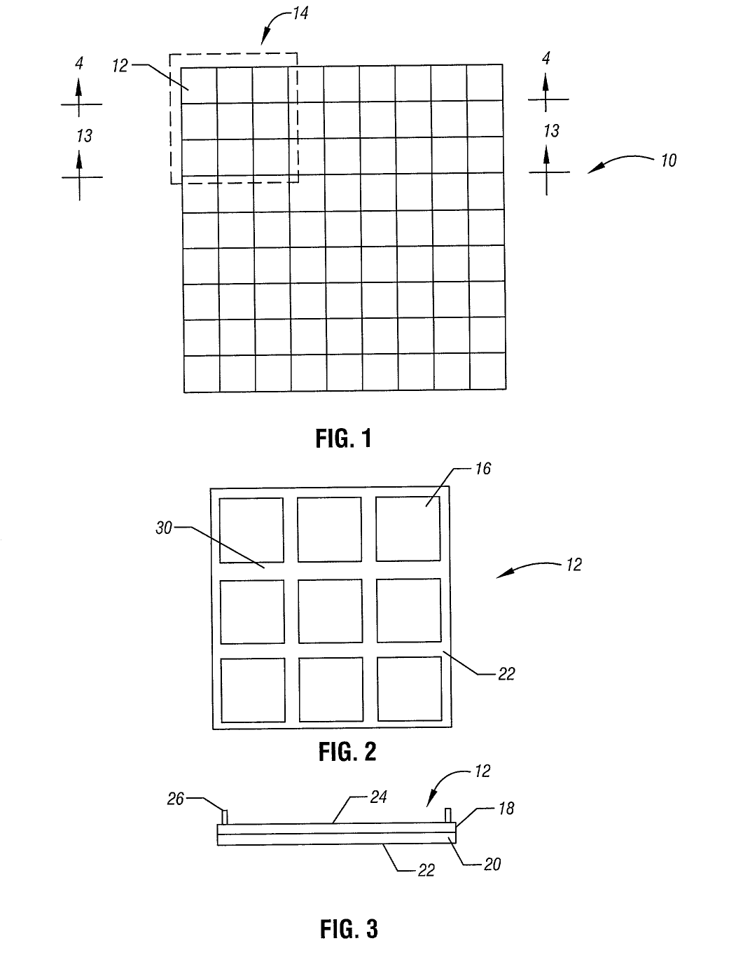

A large area display or video wall 10, shown in FIG. 1, may include a plurality of tiles 12 which are abutted together to form modules 14 which, in turn, are abutted together to form the display 10. Thus, a matrix of rows and columns of tiles form a matrix of tile modules 14 which in turn form the overall display 10.

Referring to FIG. 2, each tile 12 may include a plurality of pixels 16 that are separated by black lines 30. The black lines 30 may be black paint or other black material that is formed on the image producing side 22 of the tile 12. The black lines 30 serve to improve contrast and, in conjunction with mullions described later, helps to obscure the lines or gaps formed by the abutment of tiles 12 against one another. These lines may disrupt the seamless image produced by the combination of tiles 12. Each tile 12 produces a portion of an overall image that is completed by the juxtaposition of all the image portions contributed by all the tiles 12.

In some cases, the actual pixel 16 may be smaller than the opening defined by the black lines 30. The number of pixels 16 per tile is highly variable as is the arrangement of pixels 16 on a given tile 12.

As shown in FIG. 3, each tile 12, in one embodiment, may include a circuit board layer 18 and a display layer 20 which includes the display side 22. A set of two or more mounting pins 26 may be situated on the circuit board 18 on the rearwardly facing side 24 of the tile 12.

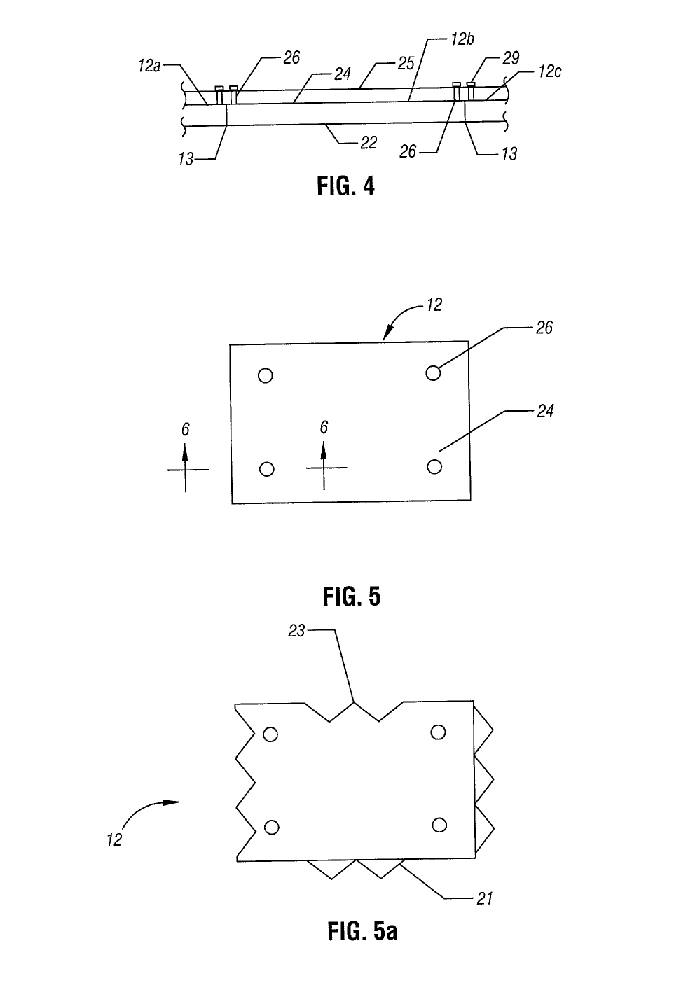

Moving next to FIG. 4, a plurality of tiles 12a, 12b and 12c may be abutted together to form interfaces 13 between adjacent tiles 12. A structural plate 25 is utilized to support the plurality of tiles 12 making up the module 14. Each tile 12 is adjustably fastened to the structural plate 25 in one embodiment of the present invention. In particular, each mounting pin 26 on the rearwardly facing side 24 of a tile 12 is passed through an opening in the structural plate 25 and secured thereto using a fastener 29 on the back side of the structural plate 25.

For example, each tile 12 may include a set of four edge situated pins 26, shown in FIG. 5, which engage the structural plate 25 in a fashion to be described in more detail hereinafter. Alternatively, each tile 12 may have the serrated edge shape shown in FIG. 5a. In such case, each tile 12 may have a tapered tab 21 adjacent tapered valleys 23. The tab 21 on one tile engages a valley 23 on an adjacent tile 12 and similarly, the tab 21 on an adjacent tile engages a tab 23. In this way, the tiles 12 are interlocked and self-positioning, in one embodiment of the present invention.

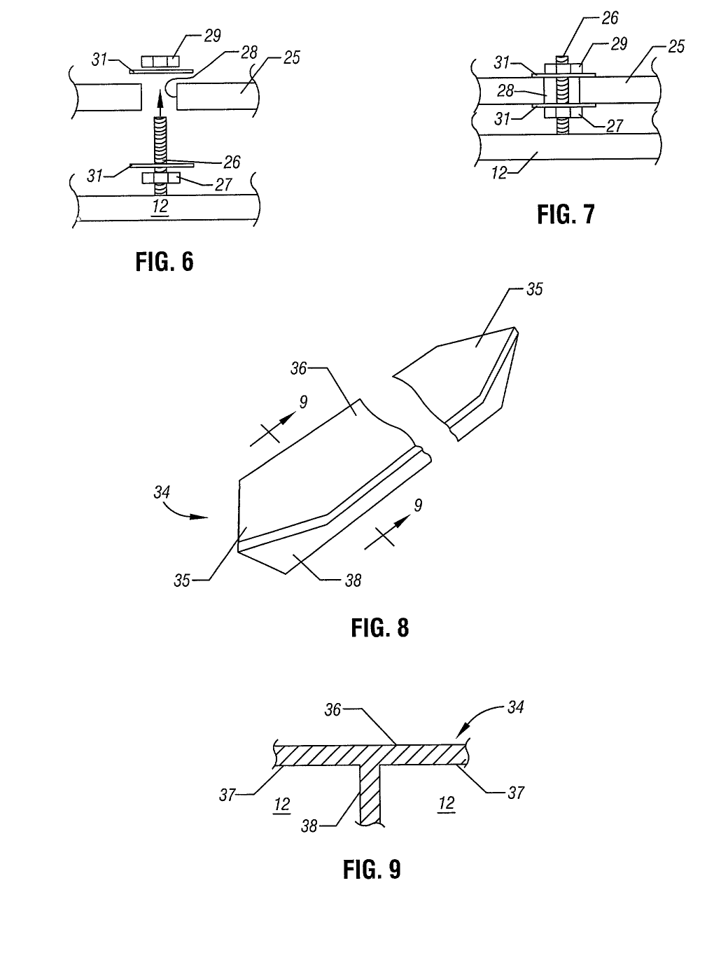

Engagement of a pin 26 with the opening 28 in a structural plate 25 is shown in FIG. 6. The pin 26 in one embodiment may have a diameter that is significantly less than the diameter of the opening 28 in the plate 25. This allows the position of the tile 12 to be adjusted with respect to the plate 25 as well as with respect to other tiles 12. By simply positioning the tile where desired by moving the pin 26 within the opening 28, the tile 12 may be aligned with other to avoid irregular appearance with and jagged resulting images.

When the tile 12 is appropriately positioned, it can be fastened using fastener 29 on the rear side of the plate 25. In one embodiment, the pin 26 may be threaded and the fastener 29 may simply be a fastening nut that threadedly engages the pin 26. The pin 26 may also be encircled by a locking nut 27 that may be threaded on the pin 26 to engage to display side surface of the structural plate 25. This adjusts the amount of extension of the pin 26 outwardly from the structural plate 25 and prevents subsequent relative movement. A washer or locking ring 31 may be included in some embodiments. As a result, each tile 12 may be positioned in a XY plane parallel to the plane of the structural plate 25 and may also be adjusted in the Z direction toward or away from the structural plate 25 in some embodiments.

Thus, as shown in FIG. 7, with the nut 29 engaging the pin 26, the tile 12 is locked in position relative to the plate 25 and other tiles 12. Through the action of the locking nut 27, the Z direction position of the tile 12 may be fixed relative to the structural plate 25 and other tiles 12.

A mullion 34, shown in FIG. 8, may be positioned between adjacent tiles 12 in some embodiments. The mullion 34 may have a width that corresponds to the width of a black line 30. In particular, the distance between pixels 16 may correspond to the width of the mullion 34. This may contribute to ensuring that a uniformly contrast enhancing pattern of black lines results which facilitates the generation of a seamless image.

In one embodiment, the mullion 34 may include a downwardly directive prong 38 that goes into the gap or interface 13 between adjacent tiles 12. A transversely directed upward surface 36 may be situated atop the tiles 12 over the interface 13, as shown in FIG. 9. Each tile 12 may include a pointed end section 35 for purposes of engaging other mullions at the intersection of four adjacent tiles 12.

Generally, the upper surface 36 of the mullion 34 is colored black. However, the underlying surfaces 37 may be white or reflective in some embodiments. In other cases, the surfaces 37 may also be black.

In some embodiments, the downwardly directed prong 38 may be transparent. In such case, the prong 38 may have an index of refraction that matches that of the adjacent glass panels used in the adjacent tiles 12. This may serve to reduce the internal reflections caused by the interface 13, particularly in the case where light is emitted outwardly from the display 10. In other cases, the prong 38 may be white or reflective to attempt to increase the amount of light that is emitted by the display 10.

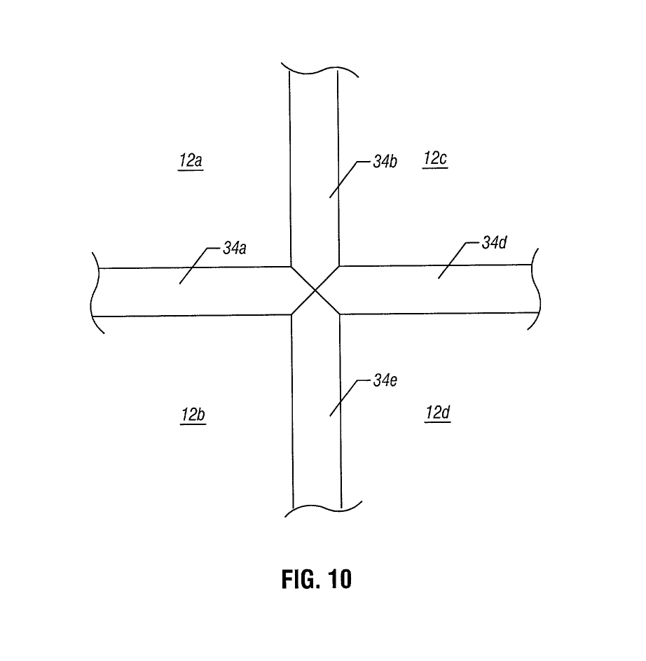

Thus, as shown in FIG. 10, the mullion 34 is situated with the upper surface 36 atop a tile 12 and the prong 38 engaging the interface 13 between adjacent tiles. The mullion 34 may be fastened by adhesive 42 to the upper surface of a tile 12 as well as to the interface 13 in some embodiments.

At the intersection of a plurality of tiles 12, the mullions 34a, 34b, 34d and 34e may engage one another using their pointed end 35, as shown in FIG. 10. Other embodiments may include other shapes for the end surfaces 35 of the mullions 34.

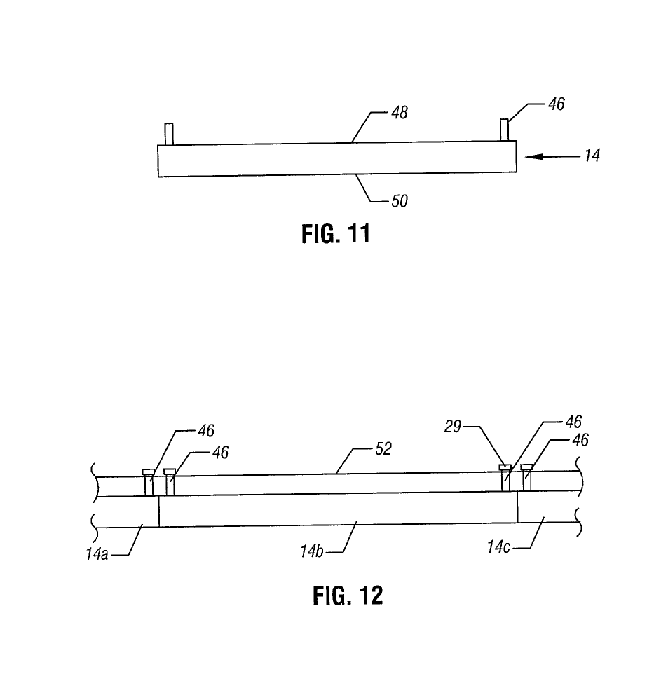

Referring to FIG. 11, a group of tiles 12 may be connected together to form a tiled module 14. Each tiled module 14 may also include pins 46 on the reverse or non-display side 48. As shown in FIG. 12, each set of adjacent modules 14a, 14b and 14c may be attached to a securing plate 52. Securing plate 52 may be a separate plate from the plate 25 utilized to secure a plurality of tiles 12. However, the attachment of the pins 46 through the plate 52 using fasteners may be as described previously with respect to the tiles.

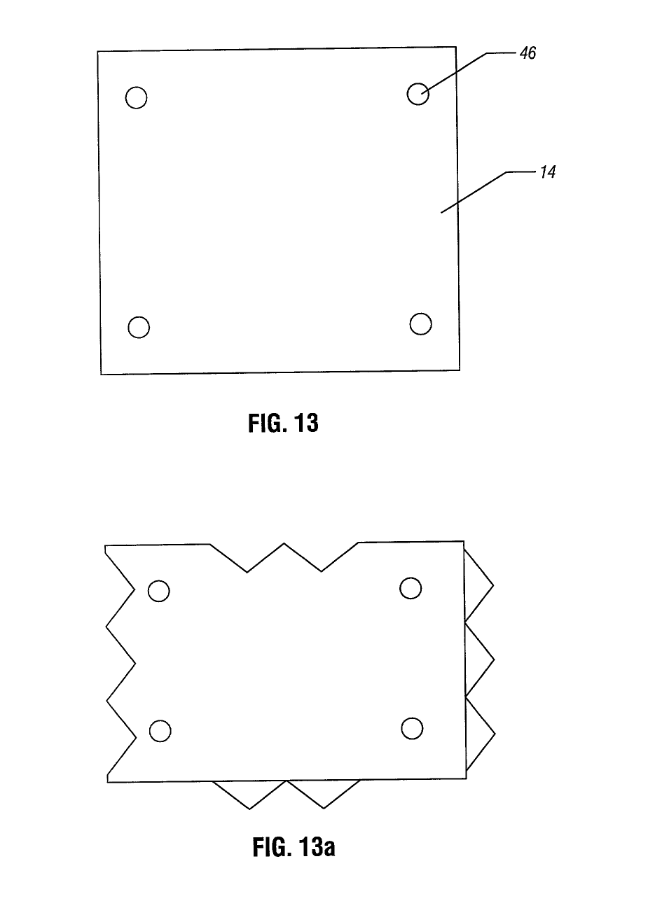

Thus, referring to FIG. 13, each module 14 includes a plurality of pins 46 that may engage fasteners 29 on the back side of the plate 52.

As indicated in FIG. 13a, the combination of tiles 12, the type shown in FIG. 5a may result in modules 14 with serrated edges including tabs 21 and valleys 23 contributed by the individual tiles.

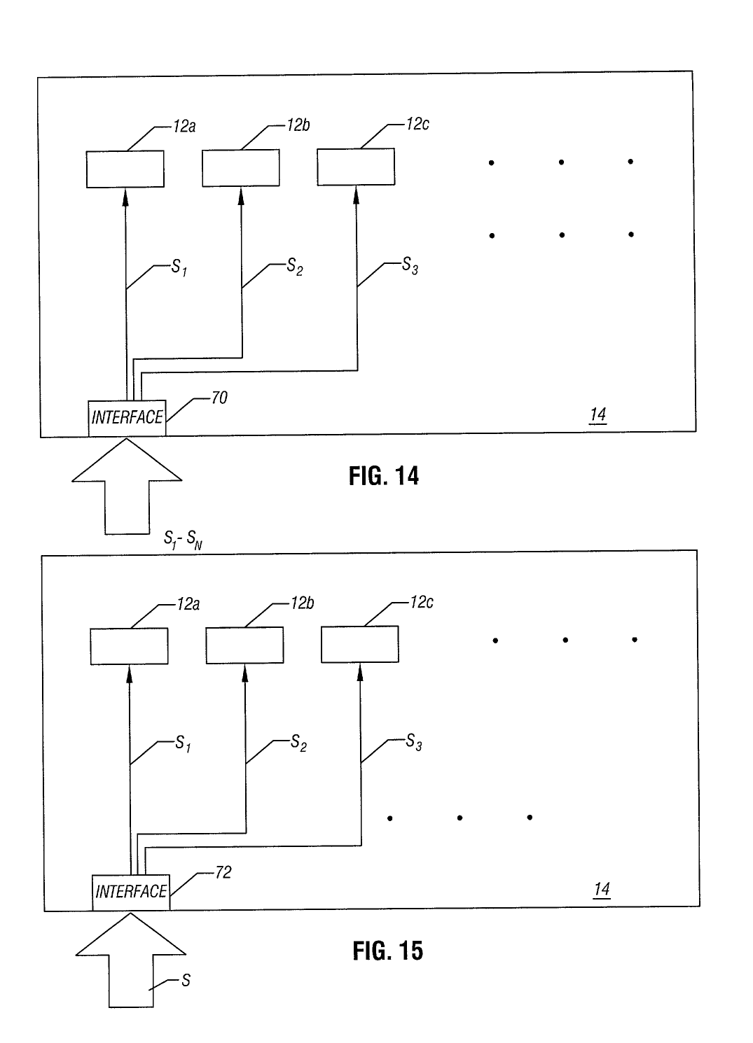

Referring next to FIG. 14, because the number of tiles 12 in any given display 10 is variable, the signals for each tile 12 may be distributed in at least two different fashions. In one approach, each display 10 receives a separate signal S₁-S_{N} for each of N tiles 12 within a given module 14. Those signals may be split at an interface 70 and distributed to each tile 12 as indicated in FIG. 14. Alternatively, signals may be sent to each module 14. That signal may then be decoded by interface 72 to generate separate signals, S₁, S₂, S₃, etc. for each of the tiles 12a, 12b and 12c, as shown in FIG. 15.

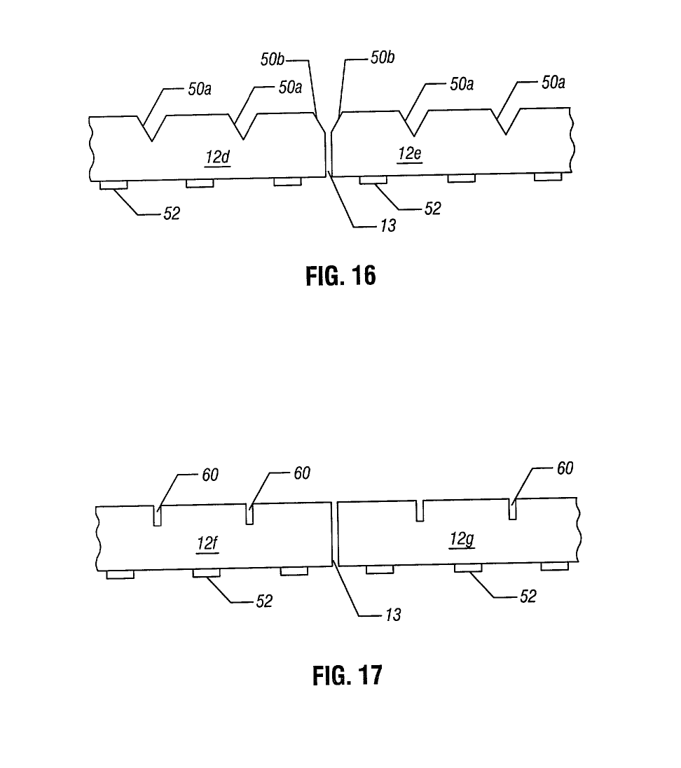

Referring to FIG. 16, a display may be made up of tiles 12d and 12e abutted along a gap 13. Surface profile features 50 may be formed in the upper surface of each tile 12d or 12e in order to further camouflage or conceal the occurrence of gaps 13. For example, the corners may be removed from the tiles 12d and 12e to create the inclined surfaces 50b, which together form a v-shaped slot.

Pixels are defined by the light emitting material 52 on the lower surface of each tile 12d or 12e. Between adjacent pixels, a v-shaped surface profile feature 50a may be formed. Thus, the presence of a regular pattern of surface profile features 50 tends to hide the occurrence of the gaps 13. As a result, the display may have a more seamless appearance.

While v-shaped grooves are shown in FIG. 16, any of a variety of other surface profile features may be regularly distributed across the upper or exposed surface of the display in order to further conceal the gaps 13. As an additional example, a plurality of slot surface profile features 60 may be formed in the upper surface of the tiles 12f and 12g as shown in FIG. 17. In one embodiment, the surface profile features 60 may have dimensions that correspond to the dimensions of the gaps 13. Thus, as shown, the gaps 13 may be defined to have a given width and the surface profile features 60a may be distributed between adjacent pixels to continue or conceal and camouflage the occurrence of the gaps 13. Because of the regular array of surface profile features 60, the gaps 13 become less evident.

As additional examples, surface profile features in the form of ridges, lenses or other structures may be provided. The periodicity of the surface profile features is such that by distributing them across the width and length of each tile 12, in a pattern that matches a feature of the gap 13, the gaps 13 simply blend into the overall appearance of the display. As a result, the presence of the gaps 13 in a tile display becomes less noticeable.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A large area display comprising:
a first structural plate; and
a first and second tile adjustably connectable to said plate, said tiles including image generating pixels, each of said tiles adjustably connectable to said plate.

2. The display of claim 1 including a set of fasteners on said first and second tiles, said fasteners fastening said first and second tiles to said first structural plate.

3. The display of claim 2 wherein said fasteners include threaded pins, said plate including holes to receive said pins, said fasteners adjustably position said tiles relative to said plate.

4. The display of claim 3 wherein the hole in said plate is of substantially greater diameter than the diameter of one of said pins.

5. The display of claim 4 including a pair of locking nuts, one on each side of said plate.

6. The display of claim 5 including at least two pins on each tile.

7. The display of claim 1 wherein each tile may be adjusted in a plane parallel to the plane of said plate and inwardly and outwardly with respect to said plane.

8. The display of claim 1 wherein said first and second tiles have alignment tabs and grooves to align the first tile relative to the second tile.

9. The display of claim 1 including mullions to fit over the gaps between said first and second tiles.

10. The display of claim 9 wherein said mullion is tee shaped including a downwardly extending prong that extends between said tiles, said prong being substantially transparent.

11. The display of claim 1 including a second structural plate and a plurality of tiles connected to a first and second structural plates, said first and second structural plates being adjustably securable to a third structural plate.

12. The display of claim 11 including a plurality of tiles connected to first and second structural plates and a plurality of first and second structural plates coupled to a third structural plate to form a large area display.

13. A method comprising:
adjustably securing a plurality of tiles to a first structural plate to form a large area display; and
adjusting the position of at least two of those tiles with respect to one another and said plate.

14. The method of claim 13 including adjustably mounting a plurality of tiles to a first structural plate and mounting a plurality of first structural plates to a second structural plate.

15. The method of claim 14 including adjustably mounting said first structural plate to said second structural plate.

16. The method of claim 15 including providing alignment devices on each tile to position each tile relative to the other tile.

17. The method of claim 13 including forming a module made up of a plurality of tiles coupled to a first structural plate and providing electrical signals to said module for each of said tiles.

18. The method of claim 13 including forming a module made up of a plurality of tiles coupled to said first structural plate and providing a signal to said module for said plurality of tiles, and separating said signal into components to drive each of said tiles.

19. The method of claim 13 including enabling said tiles to be coupled to said first structural member in the field.

20. A method comprising:
securing a plurality of display tiles to a plurality of first structural plates to form modules; and
securing a plurality of modules to a second structural plate to form a large area display.

21. The method of claim 20 including adjustably securing said plurality of tiles to first structural plates.

22. The method of claim 20 including adjustably securing said modules to said second structural plate.

23. The method of claim 20 including threadedly fastening said tiles to said first structural plates.

24. The method of claim 23 including threadedly fastening said modules to said second structural plate.

25. The method of claim 20 including securing said tiles to said first structural plates so that the position of one tile may be adjusted relative to another tile in three dimensions.

26. A large area display comprising:
a plurality of tiles arranged in an array with gaps between adjacent tiles; and
each of said tiles having a regular pattern of surface features defined in a surface of said tiles so as to camouflage the appearance of the gaps between adjacent tiles.

27. The display of claim 26 wherein said surface profile features are v-shaped.

28. The display of claim 27 wherein the region above the gaps is v-shaped.

29. The display of claim 26 wherein said surface profile features are positioned between adjacent pixels.

30. The display of claim 26 wherein said surface profile features are slot-like.
